(19) United States
(12) Patent Application Publication
(10) Pub. No.: US 2012/0165040 A1
(43) Pub. Date: Jun. 28, 2012

(54) METHOD FOR LOCATING WIRELESS NODES USING DIFFERENCE TRIANGULATION

(75) Inventors: Byung Tak Lee, Gyeonggi-Do (KR); Seok Kap Ko, Gwangju (KR); Seung Hun Oh, Gwangju (KR); Jai Sang Koh, Gwangju (KR)

(73) Assignee: Electronics and Telecommunications Research Institute, Daejeon (KR)

(21) Appl. No.: 13/296,718

(22) Filed: Nov. 15, 2011

(30) Foreign Application Priority Data
Dec. 23, 2010 (KR) 10-2010-0133969

(51) Int. Cl. H04W 24/00

(52) U.S. Cl. 455/456.1

(57) ABSTRACT

Disclosed is a method for locating wireless nodes using difference triangulation, including: storing information transmitted from three or more fixed wireless nodes while moving on a movement path; calculating displacement vectors among three or more measurement points sharing the information of three or more fixed wireless nodes on the movement path; calculating positional information of the mobile wireless node at another measurement point by reflecting the calculated displacement vectors to the positional information of the mobile wireless node calculated at a measurement point of a region where a location of at least one fixed wireless node is known; and calculating positional information of a location-unknown fixed wireless node by the positional information of the mobile wireless node calculated at the three or more measurement points and information received from the location-unknown fixed wireless node.

### CROSS-REFERENCE TO RELATED APPLICATIONS

This application is based on and claims priority from Korean Patent Application No. 10-2010-133969, filed on Dec. 23, 2010, with the Korean Intellectual Property Office, the present disclosure of which is incorporated herein in its entirety by reference.

### TECHNICAL FIELD

The present disclosure relates to a method for locating wireless nodes, and more particularly, to a method for locating fixed wireless nodes for providing a location-based service (LBS) to mobile wireless nodes under an environment having a plurality of fixed wireless nodes that are arbitrarily installed.

### BACKGROUND

Under an environment having a plurality of fixed wireless nodes (FWN) that are arbitrarily installed, the fixed wireless nodes need to be located in order to provide a location-based service (LBS) to mobile wireless nodes (MWNs).

In the related art, first, in a method for locating the fixed wireless nodes using cell IDs, when the mobile wireless nodes are connected with the fixed wireless nodes that are proactively location-managed, cell IDs of the fixed wireless nodes are allocated to the mobile wireless nodes. This method is disadvantageous in that proactive location management of the fixed wireless nodes is required.

In a locating method using triangulation, a mobile wireless node measures distances from three or more fixed wireless nodes that are proactively location-managed to calculate a present location point of the mobile wireless node in real time by using the triangulation. In this case, a method for measuring the distances includes methods such as received signal strength (RSS), time of arrival (TOA), time difference of arrival (TDOA), carrier signal's phase of arrival (POA), and angle of arrival (AOA). This method has the problem that the proactive location management of the fixed wireless nodes is required similarly as the above-mentioned method.

In a locating method using a digital radio map, a space is divided in a lattice pattern and a radio characteristic value is proactively measured for each sample point and stored in a database (a training step). Thereafter, the mobile wireless node inquires into the database by measuring the radio characteristic value in real time to determine a present location (a tracking step). This method is disadvantageous in that proactive data measurement for all lattices in a space is required.

As another method, in a method in which a location-known mobile wireless node transmits the location thereof to another wireless node, location of a location-unknown wireless node is determined through ranging or connectivity by using the location-known mobile wireless node and the corresponding wireless node becomes a newly location-known mobile wireless node to transmit the location thereof. However, this method is disadvantageous in that proactive positional information of the mobile wireless node is required and interactive communication is required between the wireless nodes.

In a method in which location-known fixed wireless nodes communicate with other fixed wireless nodes to determine the locations, some location-known fixed wireless nodes that are located at the periphery in a space perform network calibration through communication with a plurality of location-unknown fixed wireless nodes positioned inside to determine the locations of the plurality of fixed wireless nodes. This method is also disadvantageous in that interactive communication is required between the fixed wireless nodes similarly as the above-mentioned method.

That is, under the environment having the plurality of fixed wireless nodes that are arbitrarily installed, in order to provide the location-based service (LBS) to the mobile wireless nodes, the method for locating the fixed wireless nodes is required, but the above-mentioned methods in the related art are disadvantageous in that the proactive location management is required or enormous proactive data measurement or modification of hardware and software including the interactive communication between the fixed wireless nodes is required.

### SUMMARY

The present disclosure has been made in an effort to provide a method for locating wireless nodes using difference triangulation, which locates fixed wireless nodes for providing a location-based service (LBS) to mobile wireless nodes under an environment having a plurality of fixed wireless nodes that are arbitrarily installed.

The present disclosure has been made in an effort to provide a method for locating wireless nodes using difference triangulation in which a mobile wireless node locates individual fixed wireless nodes by accumulating, recording, and information-processing received signal strength (RSS) data from fixed wireless nodes without proactive location-management with respect to the fixed wireless nodes and without modifying hardware and software with respect to the fixed wireless nodes.

An exemplary embodiment of the present disclosure provides a method for locating wireless nodes using difference triangulation, including: storing, by a mobile wireless node, information transmitted from three or more fixed wireless nodes while moving on a movement path; calculating, by the mobile wireless node, displacement vectors among three or more measurement points sharing the information of three or more fixed wireless nodes on the movement path; calculating, by the mobile wireless node, positional information of the mobile wireless node at another measurement point by reflecting the calculated displacement vectors to the positional information of the mobile wireless node calculated at a measurement point of a region where a location of at least one fixed wireless node is known; and calculating, by the mobile wireless node, positional information of a location-unknown fixed wireless node by using the positional information of the mobile wireless node calculated at the three or more measurement points and information received from the location-unknown fixed wireless node.

Another exemplary embodiment of the present disclosure provides a method for locating wireless nodes using difference triangulation, including: receiving, by a central server, from a first mobile wireless node, information which the first mobile wireless node receives from three or more fixed wireless nodes at two or more measurement points on a first movement path while moving on the first movement path; receiving, by the central server, from a second mobile wireless node, information which the second mobile wireless node receives from the three or more fixed wireless nodes at measurement points other than the two or more measurement points while moving on a second movement path; calculating, by the central server, displacement vectors among the measurement points by calculating information received from the first mobile wireless node and the second mobile wireless node by using triangulation; calculating, by the central server, positional information of the mobile wireless node at each another measurement point by reflecting the calculated displacement vectors to the positional information of the mobile wireless node calculated at a measurement point of a region where a location of at least one fixed wireless node is known; and calculating, by the central server, positional information of a location-unknown fixed wireless node by using the positional information of the mobile wireless node calculated at each measurement point and information received from the location-unknown fixed wireless node.

According to the exemplary embodiments of the present disclosure, a mobile wireless node locates location points of individual fixed wireless nodes by accumulating, recording, and information-processing received signal strength (RSS) data from fixed wireless nodes to locate the fixed wireless nodes without proactive location-management with respect to the fixed wireless nodes and without modifying hardware and software with respect to the fixed wireless nodes.

The exemplary embodiments of the present disclosure can be used in a real-time location-based service for a user's mobile terminal in an exhibition hall where a plurality of WiFi access points are present, a service for determining individual locations for a plurality of ZigBee transmitters in an indoor environment, and a real-time location-based service for a mobile robot based on the WiFi access point, the ZigBee transmitter, or an RFID tag in the indoor environment.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram showing a concept of a method for locating wireless nodes using difference triangulation according to an exemplary embodiment of the present disclosure;

FIG. 2 is a diagram showing difference triangulation according to an exemplary embodiment of the present disclosure;

FIG. 3 is a diagram showing a method for locating fixed wireless nodes according to an exemplary embodiment of the present disclosure;

FIG. 4 is a flowchart showing a procedure of locating wireless nodes using difference triangulation according to an exemplary embodiment of the present disclosure;

FIGS. 5 and 6 are diagrams showing a method for locating fixed wireless nodes according to a first exemplary embodiment of the present disclosure; and

FIGS. 7 and 8 are diagrams showing a method for locating fixed wireless nodes according to a second exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The present disclosure suggests a method for locating individual fixed wireless nodes without proactive location-management with respect to the fixed wireless nodes and without modifying hardware and software with respect to the fixed wireless nodes in order to provide the location-based service (LBS) to the mobile wireless nodes under the environment having the plurality of fixed wireless nodes that are arbitrarily installed.

To this end, in the present disclosure, the mobile wireless nodes accumulates, records, and information-processes received signal strength (RSS) data from fixed wireless nodes to calculate location points of the individual fixed wireless nodes. The present disclosure suggests an information processing method including core difference triangulation in calculating the location points of the individual fixed wireless nodes by accumulating and recording, and information-processing the received signal strength (RSS) data.

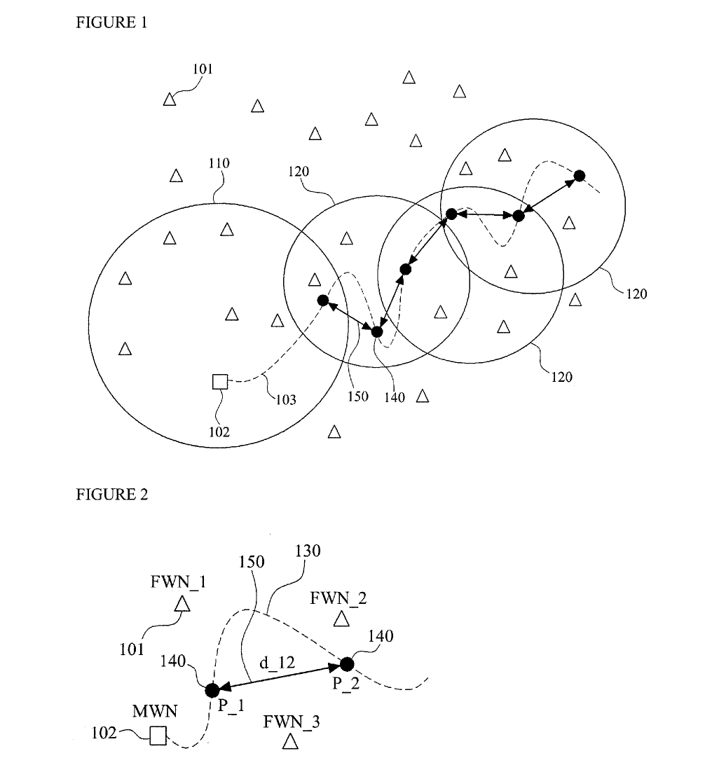

FIG. 1 is a diagram showing a concept of a method for locating wireless nodes using difference triangulation according to an exemplary embodiment of the present disclosure. In order to describe the difference triangulation in FIG. 1 with one detailed example, a calculation method of a displacement vector using the difference triangulation is shown in FIG. 2.

Referring to FIG. 1, according to the exemplary embodiment of the present disclosure, a plurality of fixed wireless nodes (hereinafter, referred to as ‘FWN’) 101 may be located through a mobile wireless node (hereinafter, referred to as ‘MWN’).

To this end, first, MWN 102 calculates a displacement vector depending on its own movement path through plural FWNs 101 and reflects the calculated displacement vector to positional information of plural location-known FWNs 101 to calculate the location of corresponding MWN 102. Thereafter, an accurate location of a location-unknown FWN 101 is calculated through the positional information of the plurality of MWNs. By repetitively performing this method, the locations of location-unknown FWNs 101 may be sequentially determined.

That is, in FIG. 1, Region A 110 represents a region where the locations of the FWNs are measured and Region B 120 represents a region where the locations of the FWNs are not measured. Therefore, according to the above-mentioned method, a location of MWN 102 for an RSS measurement point 140 on a movement path 103 is measured using the positional information of FWNs 101 of Region A 110 and the locations of FWNs 101 positioned in region 120 where the locations are not measured again are calculated by using the measured location of MWN 102. To this end, Displacement vector 150 between RSS measurement points 140 of MWN 102 is calculated and the locations of FWNs 101 positioned in Region B 120 where the locations are not measured are calculated by using calculated displacement vector 150 and the previously known positional information of FWNs 110 belonging to Region A 110. By repetitively performing this process, Region A 110 is extended and locations of other MWNs 102 belonging to the corresponding region may be measured.

Referring to FIG. 2, the MWN receives RSS information and an ID list of an FWN_1, an FWN_2, and an FWN_3 at point P_1 and performs triangulation calculation to calculate a location point of point P_1 on a local coordinate system. In the similar method, the MWN receives the RSS information and ID list of the FWN_1, the FWN_2, and the FWN_3 at point P_2 and performs triangulation calculation to calculate a location point of point P_2 on the local coordinate system.

In this case, when the MWN cannot know location point information of the FWN_1, the FWN_2, and the FWN_3 on a global coordinate system, P_1 and P_2 merely correspond to the location points on the local coordinate system, which are provided by the FWN_1, the FWN_2, and the FWN_3. A difference amount between the location point of point P_1 on the local coordinate system and the location point of point P_2 on the local coordinate system is uniquely calculated and the calculated difference amount may be expressed as a displacement vector, d_12. These series of calculation methods are core element techniques used in the present disclosure and are called the difference triangulation for convenience.

Meanwhile, according to the exemplary embodiment of the present disclosure, as the triangulation calculating methods, methods of applying triangle geometry to distance measurement methods such as received signal strength (RSS), time of arrival (TOA), time difference of arrival (TDOA), carrier signal's phase of arrival (POA), and angle of arrival (AOA) may be used and the spirit of the present disclosure is not limited to a predetermined distance measurement method.

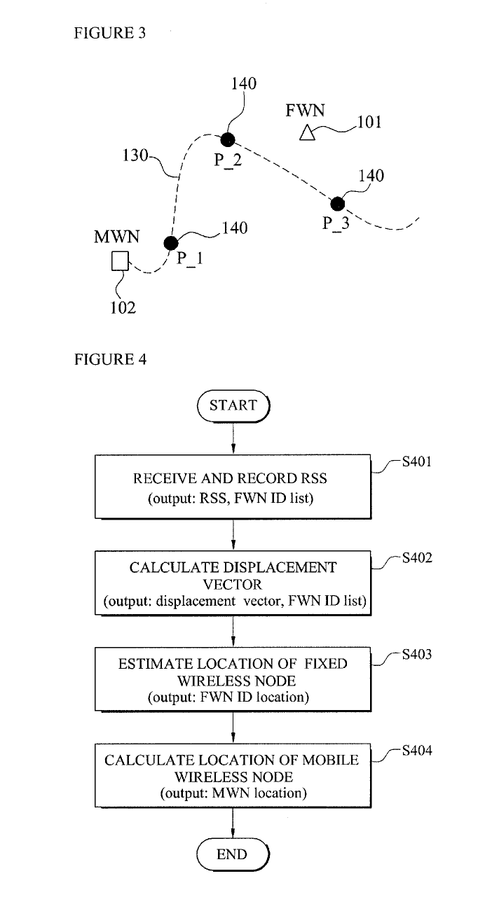

Hereinafter, referring to FIG. 3, a method for locating fixed wireless nodes from a location of a mobile wireless node according to an exemplary embodiment of the present disclosure will be described.

Referring to FIG. 3, when the MWN knows location point information of points P_1, P_2, and P_3 on the global coordinate system and RSS record information of the FWNs at each point, location point information of the FWNs on the global coordinate system and transmission power of the FWNs may be calculated by performing the triangulation calculation. However, it is assumed that the transmission power of the FWNs is not temporally changed.

A locating procedure of the wireless nodes using the difference triangulation presented by the present disclosure is shown in FIG. 4. Operations of sub-blocks will be separately described below.

First Step (S401)

An RSS receiving and recording unit of the MWN records and stores RSS information of three or more FWNs that are received at the same time together with the ID list of the FWNs.

Second Step (S402)

The MWN or a displacement vector calculating unit of a central server connected to a network performs triangulation calculation for each of two measurement points that share the RSS information of three or more FWNs and determines a relative location (that is, the displacement vector) by using the difference information.

Third Step (S403)

The MWN or an FWN locating unit of the central server connected to the network adds the displacement vector determined in the second step to a final location point of the MWN calculated in the region where the locations of the FWNs are known to calculate the location point of the MWN and extends the region where the locations of the FWNs are known by determining a location point and transmission power of one shared FWN based on the location point information of three or more MWNs and the RSS record information of the FWNs through triangulation.

Fourth Step (S404)

An MWN location calculating unit of the MWN acquires the RSS information of three or more FWNs in real time based on the known location points of the FWNs and the transmission power of the FWNs in the region where the locations of the FWNs are known to calculate a present location of the MWN.

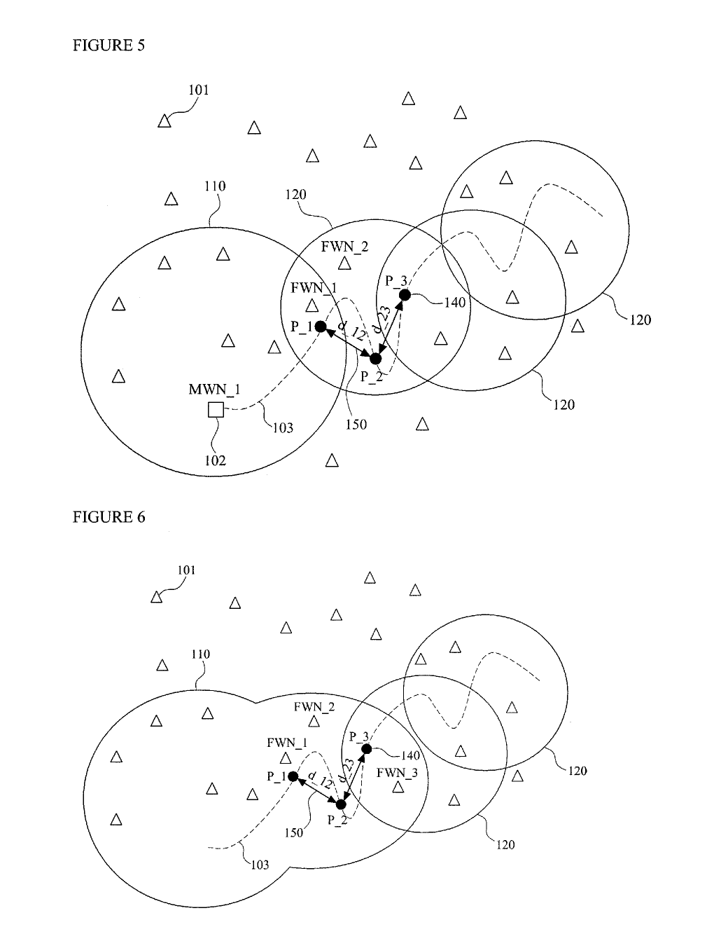

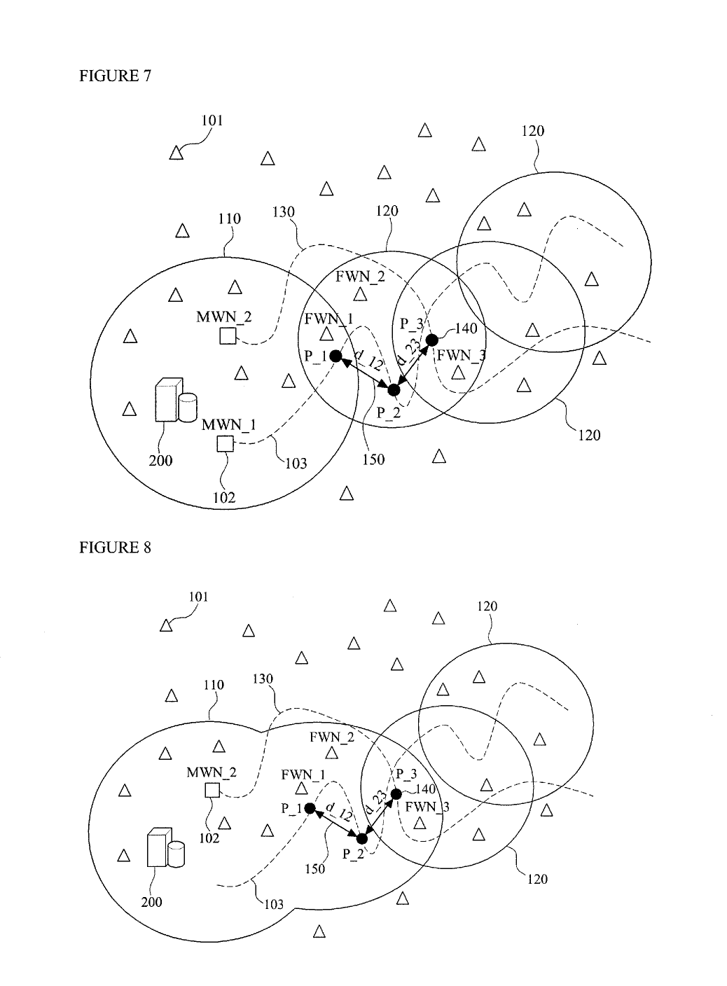

Meanwhile, a system for locating wireless nodes using the difference triangulation and an operational procedure thereof presented in the present disclosure will be described below with two exemplary embodiments. FIGS. 5 and 6 show a method according to a first exemplary embodiment and FIGS. 7 and 8 show a method according to a second exemplary embodiment.

### First Exemplary Embodiment

In the first exemplary embodiment, as a method in which one MWN locates a location point of an FWN', FIG. 5 corresponds to the first and second steps of FIG. 4 and FIG. 6 corresponds to the third and fourth steps of FIG. 4.

Referring to FIG. 5, first, as the first step, an MWN_1 records and stores RSS information and an ID list of an FWN_1, an FWN_2, and an FWN_3 at each of points P_1, P_2, and P_3. Next, as the second step, the MWN_1 performs triangulation calculation based on FWN_1/FWN_2/FWN_3 information at point P_1, performs triangulation calculation based on FWN_1/FWN_2/FWN_3 information at point P_2, and calculates a displacement vector, d_12 by using the difference information. In the similar method, a displacement vector d_23 is calculated by using the triangulation calculation and the difference information at points P_2 and P_3.

Referring to FIG. 6, as the third step, the MWN_1 calculates a location point of P_1 belonging to Region A by using the triangulation method and adds displacement vector d_12 to the P_1 location point to calculate a P_2 location point. Next, a P_3 location point is calculated by adding displacement vector d_23 to the P_2 location point. Next, a location point and transmission power of the FWN_2 are determined by using the triangulation based on the P_1, P_2, and P_3 location point information and RSS record information of the FWN_2 at each point. In the same method, the MWN_1 calculates locations of the FWN_2 and the FWN_3 and extends Region A 110 by including the FWN_2 and FWN_3.

As the fourth step, since the MWN_1 knows the location point and transmission power of each FWN belonging to extended Region A 110, the MWN_1 acquires RSS information of three or more FWNs in real time to calculate a present location.

The MWN_1 calculates the present location thereof in real time as necessary while extending Region A 110 (that is, a region where the locations of the fixed nodes are measured) by repeating the first to fours steps as described above.

### Second Exemplary Embodiment

In the second exemplary embodiment, as a method in which a plurality of MWNs locate location points of FWNs through a central server connected to a network, FIG. 7 corresponds to the first and second steps of FIG. 4 and FIG. 8 corresponds to the third and fourth steps of FIG. 4.

Referring to FIG. 7, as the first step, the MWN_1 and the MWN_2 record and store the RSS information and ID lists of the FWN_1, the FWN_2, and FWN_3 at points P_1 and P_2, and P_3, respectively, and thereafter, transfer data collected through the network to a central server 200.

As the second step, central server 200 performs triangulation calculation based on the FWN_1, FWN_2, and FWN_3 information at point P_1, performs triangulation calculation based on the FWN_1, FWN_2, and FWN_3 information at point P_2, and calculates a displacement vector d_12 by using the difference information. In the similar method, a displacement vector d_23 is calculated by using the triangulation calculation and the difference information at points P_2 and P_3.

Referring to FIG. 8, as the third step, central server 200 calculates the location point of P_1 belonging to Region A 110 by using the triangulation method, calculates the P_2 location point by adding displacement vector d_12 to the P_1 location point, and calculates the P_3 location point by adding displacement vector d_23 to the P_2 location point. The location point and transmission power of the FWN_2 are determined by using the triangulation based on the P_1, P_2, and P_3 location point information and RSS record information of the FWN_2 at each point. The location point and transmission power of the FWN_3 are determined by using the triangulation based on the P_1, P_2, and P_3 location point information and RSS record information of the FWN_3 at each point. By such a method, central server 200 calculates the points of the FWN_2 and the FWN_3 and extends Region A 110 by including the FWN_2 and the FWN_3.

As the fourth step, the MWN_1 or MWN_2 receives the location point and transmission power data of each FWN belonging to extended Region A 110 from central server 200 through the network and acquires the RSS information of three or more FWNs belonging to extended Region A 110 in real time to calculate the present location.

By the methods of FIGS. 7 and 8, the MWN_1 or MWN_2 calculates the present location thereof as necessary while extending Region A 110 in cooperation with central server 200 by repeating the first to fourth steps.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for locating wireless nodes using difference triangulation, comprising:
storing, by a mobile wireless node, information transmitted from three or more fixed wireless nodes while moving on a movement path;
calculating, by the mobile wireless node, displacement vectors among three or more measurement points sharing the information of three or more fixed wireless nodes on the movement path;
calculating, by the mobile wireless node, positional information of the mobile wireless node at another measurement point by reflecting the calculated displacement vectors to the positional information of the mobile wireless node calculated at a measurement point of a region where a location of at least one fixed wireless node is known; and
calculating, by the mobile wireless node, positional information of a location-unknown fixed wireless node by using the positional information of the mobile wireless node calculated at the three or more measurement points and information received from the location-unknown fixed wireless node.

2. The method of claim 1, wherein the information transmitted from the fixed wireless node is RSS information and ID information of the fixed wireless node.

3. The method of claim 1, wherein in the calculating of the displacement vectors, by using triangulation using any one of selected among received signal strength (RSS), time of arrival (TOA), time difference of arrival (TDOA), carrier signal's phase of arrival (POA), and angle of arrival (AOA) of the three or more fixed wireless nodes, a location point of the mobile wireless node at each measurement point on a local coordinate system is calculated and the displacement vectors are calculated by using difference information among the measurement points.

4. The method of claim 1, further comprising, after the calculating of the positional information of the fixed wireless node, calculating the positional information of the mobile wireless node by using the information transmitted from three or more fixed wireless nodes of which the positional information is calculated.

5. A method for locating wireless nodes using difference triangulation, comprising:
receiving, by a central server, from a first mobile wireless node, information which the first mobile wireless node receives from three or more fixed wireless nodes at two or more measurement points on a first movement path while moving on the first movement path;
receiving, by the central server, from a second mobile wireless node, information which the second mobile wireless node receives from the three or more fixed wireless nodes at measurement points other than the two or more measurement points while moving on a second movement path;
calculating, by the central server, displacement vectors among the measurement points by calculating information received from the first mobile wireless node and the second mobile wireless node by using triangulation;
calculating, by the central server, positional information of the mobile wireless node at each another measurement point by reflecting the calculated displacement vectors to the positional information of the mobile wireless node calculated at a measurement point of a region where a location of at least one fixed wireless node is known; and
calculating, by the central server, positional information of a location-unknown fixed wireless node by the positional information of the mobile wireless node calculated at each measurement point and information received from the location-unknown fixed wireless node.

6. The method of claim 5, wherein the information which the central server receives from the mobile wireless node is RSS information and ID information of the fixed wireless node.

7. The method of claim 5, wherein in the calculating of the displacement vectors, by using any one of selected among received signal strength (RSS), time of arrival (TOA), time difference of arrival (TDOA), carrier signal's phase of arrival (POA), and angle of arrival (AOA) of the three or more fixed wireless nodes, a location point of the mobile wireless node at each measurement point on a local coordinate system is calculated and the displacement vectors are calculated by using difference information among the measurement points.

8. The method of claim 5, further comprising, after the calculating of the positional information of the fixed wireless node, calculating the positional information of the mobile wireless node by using the information transmitted from three or more fixed wireless nodes of which the positional information is calculated.
